(19) United States
(12) Patent Application Publication
(10) Pub. No.: US 2015/0313269 A1
(43) Pub. Date: Nov. 5, 2015

(54) EGG SUBSTITUTES AND METHODS FOR MAKING THE SAME

(71) Applicant: Aniceto González Rodríguez, San Luis Potosi (MX)

(72) Inventor: Aniceto González Rodríguez, San Luis Potosi (MX)

(21) Appl. No.: 14/269,671

(22) Filed: May 5, 2014

(51) Int. Cl. A23L 1/32; A23L 1/00

(52) U.S. Cl. CPC A23L 1/3216; A23L 1/0076; A23V 2002/00

(57) ABSTRACT

The present invention is generally related to egg-substitute compositions and methods of making and using the same. The compositions according to the present invention may be a total replacement for fresh eggs in food products including bakery products, fermented doughs, cakes, pastries and sauces, as well as omelets, custards, mayonnaise, and waffles. The present compositions require no refrigeration, provide for a wide range of hydration, with extended shelf lives.

### FIELD OF THE INVENTION

The present disclosure is generally related to egg substitutes for human consumption, and more particularly using egg substitutes as ingredients in food or egg related products.

All patents and published patent applications referred to herein are incorporated by reference in their entirety.

### BACKGROUND

Bird eggs are a common food and one of the most versatile ingredients used in cooking, with chicken eggs being the most commonly used.

Chicken eggs are widely used in many types of dishes, both sweet and savory, including many baked goods including breads, cakes, cookies, custards, soufflés, muffins, scones, biscuits, pasta, dressings, sauces, and ice cream, and the like. Some of the most common preparation methods include scrambled, fried, hard-boiled, soft-boiled, omelets. In addition, the protein in raw eggs is only 51% bioavailable, whereas that of a cooked egg is nearer 91% bioavailable, meaning the protein of cooked eggs is nearly twice as absorbable as the protein from raw eggs. As an ingredient, egg yolks are an important emulsifier in the kitchen, and are also used as a thickener in custards.

Due to various reasons including, allergy, choice of diet (e.g., vegan), health (e.g., cholesterol, allergy), personal choices, or availability, one may choose to use an egg substitute, instead of bird eggs, in a recipe.

For those who do not consume eggs, alternatives used in baking include other rising agents or binding materials, such as ground flax seeds or potato starch flour. Tofu can also act as a partial binding agent, since it is high in lecithin due to its soy content. Applesauce can be used, as well as arrowroot and banana. Extracted soybean lecithin, in turn, is often used in packaged foods as an inexpensive substitute for egg-derived lecithin. These substitutes allow the product (whether baked good or an egg-dish) to maintain the nutrition and several culinary properties of real eggs.

However, these substitutes have certain limitations. For example, many of home-made egg substitutes provide only a single limited desired property of eggs in cooking, for example, mashed fruit providing moisture and binding but not leavening, and baking powder/soda and flour/water substitutes providing some leavening but limited binding properties. Some commercial substitutes made from real egg whites are associated with low shelf life and risk of carrying pathogens, and are not suitable for vegan diets. Certain other vegan egg substitute may not be suitable in baking due to low binding qualities.

Despite the advances in developing egg-substitutes, there is room for further improvement in providing enhanced egg-substitutes having greater nutritional content, consistency, and flavor; and methods for making and using the same.

### SUMMARY OF THE DISCLOSURE

The present disclosure is directed to egg substitute compositions or “ESCs” and methods for making and using the same and various products formulated therefrom.

As used herein the term “egg substitute ESC” or “ESC” refers to an egg-substitute composition embodying features of the present invention before the addition of any other ingredients and/or before further processing.

As used herein, the term “ESC-formulated egg substitute composition” or “FESC” refers to an ESC further including additional ingredients (e.g., added milk or water) rendering the ESC ready for final processing (e.g. baking) or including addition of other ingredients as directed to or preferred by a user. By way of example and not limitation, an FESC may be a pancake batter comprising an ESC according to the present invention and other ingredients and packaged prepared for convenient use by a consumer, e.g., as a “pour and bake” product.

As used herein, the term “food product” or “FP” refers to a final consumable product after addition of other ingredients and/or further processing, which renders the ESC ready for general consumption or use, as for example, a mayonnaise, dressing or a cake. As used herein, the terms “re-constitute” and “re-constituted” are used in their ordinary meanings to mean: “to constitute again or anew” and “constituted again or anew.”

An exemplary method 100 embodying features of the present invention for preparing a food substitute, including an egg substitutive composition (“ESC”), includes a plurality of stages including: preparation of an oil/water emulsion, activation of emulsifying agents, retention of moisture through control of water activity, preparation of a blending complex including macro ingredients and micro ingredients, and extrusion of a mixture including the activated emulsion mixture and the blending complex, yielding a hydrated ESC. In an embodiment, the resulting mixture may be dried to yield a dried ESC and further homogenized during a homogenization step.

In an embodiment, the control of water activity includes hydrating a mixture including mineral salts to yield an ORTHO complex, with the blending complex including a macro complex including proteins, carbohydrates, and insoluble fibers; and a micro blend including the ortho salts.

In an exemplary embodiment, a method of preparing an egg substitute composition, comprises: Preparing an oil in water emulsion mix; Homogenizing the emulsion mix; Preparing a mixture of ortho salts; Preparing a blending complex comprising a macro complex including proteins, carbohydrates, and insoluble fibers; and a micro blend including the ortho salts; Extruding a mixture comprising the homogenized emulsion mixture and the blending complex yielding a hydrated egg replacement composition.

In an embodiment, the emulsion mix comprises an oil phase including emulsifiers and stabilizers and the aqueous phase includes lubricants and buffer salts. The homogenizing step reduces size of fat globules in the emulsion mix. In an embodiment, the preparation of the oil in water emulsion mix forms a uniform thin film for coating the protein particles of the macro complex. In an embodiment, the thin film aids in retention of moisture by the protein particles and expansion thereof.

The ortho salts may be formed at least in part by hydration of anhydrous salts which are thereafter used in the micro-blend. The ortho salts result in a food composition with enhanced hydration characteristics. It is believed that the hydration of the salts aids in moisture retention and water activity control of the composition In an embodiment, the extrusion step results in the coating of solid particles by a thin uniform and temperature resistant film formed by the homogenized emulsion. The reduction in size of fat globules by way of the homogenizing step creates a composition having physiochemical characteristics similar to those of fresh eggs.

In an embodiment, the process further includes the steps of drying of the ESC and homogenizing the ESC.

In an embodiment, an ESC prepared according to methods embodying features of the present invention has a hydration ratio from about 1:4 (egg replacement composition:water) to about 1:6 (egg replacement composition:water).

An egg substitute composition (“ESC”), embodying features of the present invention comprises: proteins, fats, binding agents, emulsifiers, enzymes, thickening agents, and mineral salts. The present ESCs embodying features of the present invention may include any one or more of the following characteristics: no-refrigeration needed, total or substantially total replacement for natural eggs, wide range of hydration (e.g., 1 part ESC to 6 parts water), long shelf life (e.g., 12 months), improved storage efficiency, and cost reduction, and conformance to diverse dietary requirements including those of different life styles.

In an embodiment, the ESC comprises from about 1 to about 30% by weight protein, from about 0 to about 30% by weight fats, from about 1 to about 45% by weight binding agents, from about 0 to about 25% by weight emulsifiers, from about 0.01 to about 0.08% by weight enzymes, from about 0 to about 20% by weight thickening agents, and from about 0.02 to about 2.50% by weight mineral salts. The ESC may be further formulated into an aqueous composition ready for use for preparation of final food product.

The above and other features of the present invention, which will become more apparent as the description proceeds, are best understood by considering the following Detailed Description in conjunction with the accompanying drawings, wherein like characters represent like parts throughout the several views.

### BRIEF DESCRIPTION OF THE DRAWINGS

Non-limiting and non-exhaustive features of the present invention are described with reference to the following figures, wherein like reference numerals refer to like parts throughout the various figures.

FIG. 1 is a schematic of a process for preparing egg substitute compositions embodying features of the present invention.

FIG. 2 is a schematic of a process for the preparation of the oil/water mixture stage of FIG. 1 embodying features of the present invention.

FIG. 3 is a schematic of a process for preparation of the emulsion activation stage of FIG. 1 embodying features of the present invention.

FIG. 4 is a schematic of a process for controlling water activity stage of FIG. 1 embodying features of the present invention.

FIG. 5 is a schematic of a process for preparation of the blending complex of FIG. 1 embodying features of the present invention.

FIG. 6 is a schematic of a process for the extrusion stage of FIG. 1 embodying features of the present invention.

FIG. 7 is a schematic of a process for preparation of the drying stage of FIG. 1 embodying features of the present invention.

FIG. 8 is a schematic of a process for the homogenization stage of FIG. 1 embodying features of the present invention.

### DETAILED DESCRIPTION

The present disclosure is directed to egg substitute compositions or “ESCs” and methods for making and using the same and various products formulated therefrom.

Embodiments of the invention are described below with reference to exemplary ESCs, products, and methods for illustration. It should be understood that numerous specific details, relationships, and methods are set forth to provide a full understanding of the invention. One having ordinary skill in the relevant art, however, will readily recognize that the invention can be practiced without one or more of the specific details or ingredients or with other methods.

As used herein the term “egg substitute ESC” or “ESC” refers to an egg-substitute composition embodying features of the present invention before the addition of any other ingredients and/or before further processing.

As used herein, the term “ESC-formulated egg substitute composition” or “FESC” refers to an ESC further including additional ingredients (e.g., added milk or water) rendering the ESC ready for final processing (e.g. baking) or including addition of other ingredients as directed to or preferred by a user. By way of example and not limitation, an FESC may be a pancake batter comprising an ESC according to the present invention and other ingredients and packaged prepared for convenient use by a consumer, e.g., as a “pour and bake” product.

As used herein, the term “food product” or “FP” refers to a final consumable product after addition of other ingredients and/or further processing, which renders the ESC ready for general consumption or use, as for example, a mayonnaise, dressing or a cake.

Features of exemplary ESCs, methods of making and using the same; as well as exemplary FESCs or FPs using the ESCs, and method for making the same, will be explained in reference to the following figures, descriptions, formulations, and examples. It should be noted that either or both ESC and product elements/ingredients may be intended when referring to the following figures/examples.

As used herein, the terms “re-constitute” and “re-constituted” are used in their ordinary meanings to mean: “to constitute again or anew” and “constituted again or anew.”

In some embodiments, the egg substitute compositions (or ESCs) may be used as a replacement for whole eggs, egg yolks, or egg whites in food products. In some embodiments, the food products can be baked goods such as but not limited to muffins, cakes, cupcakes, brownies, cookies, biscotti, pancakes, breads, waffles, pastries, pies, tarts, scones, pretzels, crackers. In some embodiments, the ESCs may be used as a replacement for eggs or egg parts in other products such as but not limited to pasta, noodles, meatloaf, burgers, custards, sauces, ice cream, mayonnaise, and/or salad dressings.

In some embodiments, the ESCs can be used as a replacement for whole eggs, egg yolks, or egg whites in non-food products, such as but not limited to shampoos, facial washes or masks, creams, films, encapsulates.

In some embodiments, the present ESCs exhibit functionalities similar to those of natural eggs. The present ESCs embodying features of the present invention may include any one or more of the following characteristics: no-refrigeration needed, total or substantially total replacement for natural eggs, wide range of hydration (e.g., 1 part ESC to 6 parts water), long shelf life (e.g., 12 months), improved storage efficiency, and cost reduction, and conformance to diverse dietary requirements including those of different life styles.

The ESCs embodying features of the present invention may be formulated as vegan and/or non-vegan to suit a variety of products, including omelets, pastries, waffles, custards, meringues, mayonnaise; and baking products (e.g., muffins, pound cakes, sponge cakes, hot cakes, cream cakes, cookies, baguettes, breads).

ESCs embodying features of the present invention provide for a high egg equivalency, ranging from about 10 to about 12 grams (g), from about 12 to about 15 g, from about 15 to about 17 g, from about 17 to 20 g; as calculated per 100 g of eggs. By way of example, the ESCs have a wide range of hydration (about 1 to about 6) as for example, about 14-about 17 g of ESC when mixed with about 86 to about 83 g of water may yield 100 g of FESC (ESC+Water). In some embodiments, according to the present invention exhibit fewer calories as compared to natural eggs, ranging from about 40 to about 50 percent (%), from about 50 to about 60%, from about 60 to about 65%, from about 65 to about 70%, from about 70 to about 75%, from about 75 to about 80%, from about 80 to about 90%.

In some embodiments, ESCs according to the present invention exhibit fewer amount of fat and cholesterol as compared to natural eggs, ranging, independently, from about 0 to about 3%, from about 3 to about 6%, from about 6 to about 8%, from about 8 to about 10%, from about 10 to about 13%, from about 13 to about 15%.

In some embodiments, the ESCs according to the present invention have lower sodium as compared to natural eggs, ranging from about 0 to about 3%, from about 3 to about 6%, from about 6 to about 8%, from about 8 to about 10%, from about 10 to about 13%, from about 13 to about 15%.

In some embodiments, the ESCs according to the present invention, exhibit no or lower vulnerability to any one or more contaminants such as Salmonella, Staphylococcus Aureus, and Shigella.

Form

The egg substitute compositions (or ESCs) embodying features of the present invention may be provided in either liquid or solid form, or a form in-between (e.g., gel, paste, or concentrate). In an embodiment, the ESC is provided in a powdered form. The ESCs may be used as an instantly usable egg substitute.

In some embodiments, the ESC may be reconstituted with some form of liquid such as water or milk for use in preparation of the desired food product/article, before the addition of any other ingredients. In some embodiments, liquid is added to a dry or concentrated egg substitute composition in an amount sufficient to render the ESC suitable for use in the preparation of the food product and to render it similar to natural egg.

Egg Substitute Compositions (ESCs) Ingredients

Protein

The edible portion of natural egg contains from about 5 to about 15% (by weight), normally 13%, protein which is found in both the yolk and the albumen. Although protein is more concentrated around the yolk, there is in fact more protein in the albumen.

In some embodiments, ESCs provided herein comprise proteins, polypeptides, and/or peptides, referred to collectively as “protein.” In some embodiments, the ESCs may comprise from about 1 to about 5%, from about 2 to about 10%, from about 5 to about 12%, from about 5 to about 20%, from about 10 to about 30% protein, by dry weight or total weight. In some embodiments, ESCs may comprise about 1%, about 2%, about 3%, about 4%, about 5%, about 7%, about 10%, about 12%, about 15%, about 20%, about 25%, about 30% protein; by dry weight or total weight.

In some embodiments, the proteins in the ESC may comprise one or more plant-based proteins in any suitable form. In some embodiments, the one or more plant-based proteins may include, but are not limited to: pea proteins, garbanzo (i.e., chickpea) proteins, fava bean protein, soy proteins, rice proteins, potato proteins, hemp proteins, canola protein, or any combinations thereof. Other sources of plant-based protein may include, but are not limited to: canola wheat, zein, rice, oat, potato, peanut, pea (e.g., green or yellow), green bean, and legumes such as pulses such as lentils.

The plant-based proteins may comprise all forms including concentrate and fractured. In some embodiments, proteins in the ESC may comprise native and/or denatured proteins. In some embodiments none or essentially no animal proteins are used in ESCs. In some embodiments, the ESCs comprise animal based protein such as egg protein.

Oil/Fat

Natural chicken eggs typically comprise about 10% fat content by weight. The fat content of natural eggs provides some of the desired moisture and texture to the egg-containing product (e.g., cake), thus improving texture of the product. The fat of an egg is found almost entirely in the yolk; there is normally less than 0.5% fat in the albumen. Most of an egg's total fatty acid composition is monounsaturated (approximately 38%). About a further 16% is polyunsaturated and only 28% is saturated. An average medium size egg contains about 186 to about 200 milligram (mg) cholesterol. In some embodiments, the ESCs may provide fat profile similar to or lower than that of natural eggs.

In some embodiments, the fat content of the ESCs comprise plant-based oils. In some embodiments, the plant-based oils may comprise canola oil, sunflower oil, safflower oil, coconut oil, corn oil, olive oil, peanut oil, or palm oil. In some embodiments, the plant-based oils may comprise oils from beans (e.g., garbanzo beans or fava beans).

In some embodiments, the ESCs have none or substantially no fat. In some embodiments, the ESCs comprise from about from about 0.1 to about 10%, about 0.5-15%, about 1-20%, or about 5-30% fat by total weight (animal, plant-based, or a combination thereof). In some embodiments the ESCs comprise about 0.1% or less, about 0.2% or less, about 0.5% or less, about 1%, about 2%, about 3%, about 4%, about 5%, about 7.5%, about 10%, about 15%, about 20%, about 25%, about 30%, fat by dry weight or total weight (animal, plant-based, or a combination thereof). In some embodiments the ESCs comprise less than about 3%, less than about 2%, less than about 1%, less than about 0.5%, or less than about 0.1% fat (animal, plant-based, or a combination thereof).

Natural eggs typically comprise about 3% saturated fats. The saturated fat content of eggs may deter significant numbers of consumers from enjoying eggs or egg-containing products. In some embodiments, the ESCs comprise less than 3%, less than 2%, less than 1%, less than 0.5%, less than 0.1%, or essentially no saturated fat (animal, plant-based, or a combination thereof).

In some embodiments, the ESCs are essentially or totally free of fat and/or oil attributed to any one or more of, animal fats or oils, vegetable oils, or synthetic oils. In an embodiment, the ESC contains none or substantially no cholesterol.

Lecithin

In some embodiments, the ESCs may comprise lecithin. Lecithin is a group of yellow brownish fatty substances present in animal and plant tissues, as well as egg yolk. Lecithin serves as an emulsifier, has a similar fat profile to that of eggs, and is non-allergenic. In some embodiments, lecithin may be plant-based, including those found in garbanzo bean, fava bean, soy, sunflower, canola, or a combination thereof. In some embodiments, the ESCs may comprise 0%, from about 0.01% to about 25%, about 0.1% to about 20%, about 1 to about 25%, about 0.01% to about 10%, or about 4% of lecithin by dry weight of total weight.

Enzymes

Natural eggs contain a number of enzymes that are used in human consumable products. For example, lysozyme may be extracted from egg whites and can be used as a cheese preservative. The ESCs enzyme profile may be similar or dissimilar to that of eggs. In some embodiments, the ESCs contain lysozyme. In some embodiments the ESCs comprise enzymes that replicate the function of the natural egg enzymes. For example, a natural egg enzyme may catalyze a particular known chemical reaction. ESCs embodying features of the present invention may contain enzymes that catalyze the same or a similar reaction, including any one or combination of bromelain, amylase, protease; amongst others. In some embodiments, the ESC composition may include, as a percentage of the dry weight, from about 0.01 to about 0.08% enzymes; from about 0.02 to about 0.06% bromelain; from about 0.01 to about 0.05% amylase, from about 0.03 to about 0.075 protease.

Nutrients and Vitamins

Natural eggs contain most of the recognized vitamins with the exception of vitamin C. The egg is a source of all the known B vitamins. It is a particularly rich source of vitamins B12 and riboflavin (vitamin B2) and a useful source of folate. The egg is also a good source of the fat-soluble vitamins A and D and provides some vitamin E.

The ESCs may have a nutrient (e.g., vitamin, choline) profile similar, dissimilar, or superior to that of eggs by equivalent weight. Table I lists exemplary, independent, and nominal values of various nutrients in ESCs embodying features of the present invention, equivalent to a large size egg (e.g., about 50 g).

TABLE I

| VITAMIN | UNIT | VALUE |
|---|---|---|
| Choline | mg | 112 |
| Riboflavin | mg | 0.18 |
| Vitamin B12 | μg | 0.40 |
| Folate | μg | 21 |
| Vitamin D | Ui | 36 |
| Vitamin A | Ui | 240 |
| Vitamin B6 | mg | 0.08 |
| Vitamin E | mg | 0.40 |

In some embodiments, the ESCs provide a vitamin and nutrient profile similar, dissimilar, or superior to that of eggs. In some embodiments, the ESCs can be fortified with vitamins and nutrients to provide a high nutritional value per unit weight compared to natural eggs.

Minerals and Trace Elements

The ESCs may have a mineral and trace elements (e.g., vitamin, choline) profile similar, dissimilar, or superior to that of eggs by equivalent weight. Table II lists exemplary, independent, and nominal values of various nutrients in a ESCs embodying features of the present invention, equivalent to a large size egg.

TABLE II

| MINERAL | UNIT | VALUE |
|---|---|---|
| Selenium | μg | 13 |
| Phosphorus | mg | 89 |
| Iron | mg | 0.79 |
| Zinc | mg | 0.58 |
| Calcium | mg | 25 |
| Sodium | mg | 80.85 |
| Potassium | mg | 62 |
| Magnesium | mg | 5.4 |

In some embodiments, the ESCs provide a mineral and element profile similar, dissimilar, or superior to that of eggs. In some embodiments, the ESCs can be fortified with minerals and elements to provide a high nutritional value per unit weight compared to natural eggs.

In some embodiments, the ESCs may comprise magnesium chloride (e.g., nigari) and/or papain (e.g., papaya enzyme).

Flours/Starches

In some embodiments, the ESCs comprise one or more flours, i.e. starches. In some embodiments, flour is a powder ground from any one or more of grains, seeds, roots, or other sources. Most flours have a high starch content that imparts thickening and binding properties, and may provide moisture content. In some embodiments, the one or more flours may be selected from all-purpose flour, unbleached flour, bleached flour, bread flour, self-rising flour, wheat flour, cake flour, acorn flour, almond flour, amaranth flour, atta flour, rice flour, buckwheat flour, cassava flour, chestnut flour, chuno flour, coconut flour, corn (maize) flour, hemp flour, maida flour, mesquite flour, nut flour, peanut flour, potato flour, rice flour, rye flour, tapioca flour, t'eff flour, soy flour, peanut flour, arrowroot flour, taro flour, acorn flour, bean flours such as, e.g., soy flour, garbanzo flour, fava bean flour, pea flour; or other flour.

In some embodiments, the one or more flours are selected from sorghum, white sorghum, soy bean, millet, vallarta, stueben, green fagelot, black beluga, black calypso, chana dal amaranth, lentil, red lentil, black lentil, golden lentil, do pung-style lentil, sprouted green lentil, sweet brown rice, navy bean, red bean, pink bean, canellini bean, giant white lima bean, christmas lime bean, baby lima bean, mung bean, peeled fava bean, good mother stellard bean, cranberry chorlottis bean, Santa Maria pinguinto bean, brown tepary bean, black turtle bean, yellow slit pea, canadian yellow pea, black turtle beans, brown teff flour, rye flour, quinoa flour, potato flour, white rice flour, brown rice flour, oat flour, buckwheat flour, whole grain corn flour, stone ground cornmeal, pre-cooked split pea, pre-cooked garbanzo flour, arrowroot powder, and potato starch.

Gums

“Gums” refers to materials that act as gelling agents, often comprising polysaccharides and/or glycoproteins. Gums, such as xanthan gum, can be used in small amounts to provide significant thickening and viscosity, and can also be used to replace fat and emulsifiers.

In some embodiments, the ESC may also comprise one or more gums, such as, e.g., xanthan gum, acacia gum, gellan gum, guar gum, locust bean gum, tragacanth gum, carrageenan gum, or a combination thereof.

In some embodiments, gums may comprise about 0.5 to about 20%, about 1 to about 15%, about 2 to about 10%, of the dry weight or total weight of the ESC. In some embodiments, gums may comprise from about 1 to about 10%, about 1 to about 5% of the dry weight or total weight of the ESC. In some embodiments, the ESC may comprise any one or more of xanthan gum, acacia gum, or a combination thereof. In some embodiments, the one or more gums may comprise about 0.5%, 1%, 2%, 3%, 4%, 5%, 6%, 7%, 8%, 9%, 10%, 12.5%, 15%, or 20% of the dry weight or total weight of the ESC.

In some embodiments, the ESC may comprise a single gum only. In some embodiments, the single gum may be xanthan gum or acacia gum. In particular embodiments, the ESC may comprise about 1 to about 10% xanthan gum.

Mixes of guar gum and xanthan gum may be available commercially, such as those available from TIC Gums, under the names Pre-Hydrated®, or Ticalose® CMC 2500 Powder.

High-Fiber Content

In some embodiments, the ESCs may comprise a material with high-fiber content. In some embodiments, fiber in the ESC may provide a high water-holding capacity that contributes to the overall texture of the final food product. In some embodiments, the high fiber material may be bran, e.g. wheat bran, oat bran, corn bran, rice bran, or other bran. In some embodiments, the bran may be micronized into a fine powder. In some embodiments, the high fiber material may comprise from about 0.5 to about 50%, about 1 to about 30%, about 2 to about 20% of the dry weight or total weight of the ESC. In some embodiments, the high fiber material may comprise 0%, about 0.5%, about 1%, about 2%, about 3%, about 4%, about 5%, about 6%, about 7%, about 8%, about 9%, about 10%, about 12.5%, about 15%, about 20%, about 30%, about 40%, about 50% of the dry weight or total weight of the ESC.

Gypsum

In some embodiments, the ESC may comprise gypsum (calcium sulfate). Gypsum can advantageously provide coagulation and thickening properties. In some cases, the gypsum can be terra alba (calcium sulfate dihydrate). In some embodiments, the ESC may include, 0%, from about 0.5% to about 20%, from about 1% to about 15%, from about 0.5% to about 12%, from about 0.5% to about 2% by dry weight or total weight of ESC.

Acids And Bases

In some embodiments, the ESC may comprise one or more bases, e.g., potassium carbonate or calcium carbonate. In some embodiments, the ESC may comprise one or more acids, e.g., citric acid. The one or more acids and/or bases may be utilized to modify the pH of the ESC. The ESC may comprise about 0%, from about 0.5% to about 30%, from about 0.5% to about 15%, from about 0.5% to about 5% by total weight by dry weight or total weight.

In some embodiments, the ESC may comprise sodium bicarbonate (baking soda), baking powder, calcium lactate (including a calcium lactate not derived from dairy), calcium carbonate, or Versawhip 6000 (enzyme-altered soy protein, may replace a part or all of the percentage of the protein). In some embodiments, these agents may be utilized as additional leavening agents in the ESC. In some embodiments, the ESC may comprise 0%, about 1% to about 20%, about 2 to about 12%, by dry weight or by total weight of leaveners.

Coloring Agents

In some embodiments, the ESC may comprise one or more coloring agents. Natural or artificial coloring agents may include, caretenoids such as beta-carotene, turmeric, annatto, mango yellow, or palm-based oils. In some embodiments, the ESC may comprise about 0%, from about 0.1% to about 20%, about 0.5% to about 15% by dry weight or by total weight.

Flavoring Agents

In some embodiments, the ESC may comprise one or more flavoring agents. Various natural or artificial flavoring agents may include, for example, salt, spices, sugar, sweeteners, monosodium glutamate, sulfuric flavoring agents such as black salt, or other flavoring agents.

Physical Properties of the ESCs

Viscosity

Natural eggs can provide a desired viscosity to batter or dough for the preparation of baked goods. Viscosity can be qualitatively assessed by the rate or ease of flow, the ease of movement during handling, or may be quantitatively assessed by viscometers or rheometers. In some embodiments, the ESCs may provide a desired viscosity to the batter or dough similar to batter or dough prepared using natural eggs. In some embodiments, reconstituted ESC has a viscosity from about 1 to about 30%, from about 20 to about 50%, from about 30 to about 70%, from about 40 to about 90%, from about 60 to about 100%, from about 90% to about 140% of the desired viscosity of natural eggs.

In some embodiments, reconstituted ESCs have at least 1%, about 2%, about 3%, about 4%, about 5%, about 10%, about 15%, about 20%, about 30%, about 40%, about 50%, about 60%, about 70%, about 80%, about 90%, about 100% of the desired viscosity of a natural egg. In some embodiments the above viscosity may be that of a raw product or of a prepared (e.g., cooked) product, or in a chemically cross-linked product.

pH

Natural eggs may have a pH range of about 6-8, although the pH of eggs can vary widely with freshness or other environmental factors. In some embodiments, the pH of reconstituted ESCs may range from about 5.5 to about 8.5, about 6 to about 8, about 6.5 to about 7.5, about 7, about 7.5, about 8. In some embodiments, the pH of the reconstituted ESC provided herein is different than natural eggs, e.g. more acidic or more basic than a natural egg.

Texture

Eggs are commonly used to provide moisture and fat to a product recipe, resulting in a non-dry texture. The ability of an egg or egg substitute to provide the desired moisture and fat to a product recipe (such as, for example, cake or bread recipes) may be indicated by the texture of the finished product, e.g., whether the product produces a moist or dry crumb. In some embodiments, the ESCs provide a moisture imparting quality. In some embodiments, the ESC has from about 1 to about 30%, about 20 to about 50%, about 30 to about 70%, about 40 to about 90%, about 60 to about 100% of the desired moisture and feel of a natural egg, as for example when comparing a food product prepared from ESC to similar food product prepared from natural eggs.

Color

Eggs can sometimes be used to provide a certain color to the food or non-food product. In some embodiments, the ESCs may provide same or similar color to the food product.

Flavor

Eggs can be sometimes used to provide a certain “eggy” taste to the food product. Taste may be qualitatively assessed by blind taste test of the product prepared using the ESCs compared to the product prepared using an equivalent amount of eggs. In some embodiments, the ESC may provide a taste that is the same, similar, different, or taste neutral as compared to a food product made with natural eggs.

Functional Properties of ESCs

Functional properties may be evaluated by actual measurements or comparative testing of food products made with ESCs and reference ingredients (e.g., natural egg).

The current ESCs may have one or more qualities of natural eggs. In various embodiments, binding, moisturizing, leavening, and/or emulsifying, or other properties of the ESCs are determined to be similar to an egg if measured at between about 90-110% of the binding, moisturizing, leavening, and/or emulsifying properties of an egg.

Binding Properties

Natural eggs provide binding properties that are useful in many cooking and non-cooking applications. Binding properties can refer to the properties of natural eggs that provide structural integrity to egg-containing or ESC containing products, e.g., baked goods. Structural integrity of an egg-containing or ESC containing product may be compared and/or indicated by, for example, whether the product falls apart during or after preparation, or by the quantity of fragments or crumbs that are generated when the product is handled. In some embodiments, the ESCs provide binding properties similar to that of natural eggs. In some embodiments, the ESC has from about 1 to about 30%, from about 20 to about 50%, from about 30 to about 70%, from about 40 to about 90%, from about 60 to about 100% of the binding properties of a natural egg.

Water Activity

Water activity (or “aw”) represents the intensity with which water associates with various non-aqueous constituents and solids. Simply stated, it is a measure of the energy status of the water in a system. Natural eggs provide aw properties that are useful in many cooking and non-cooking applications. Water activity properties can refer to the properties of natural eggs that provide shelf life and freshness to egg-containing or ESC containing products, e.g., baked goods. In some embodiments, the ESCs provide aw properties similar to or less than that of natural eggs. In some embodiments, the ESC has from about 96.5 to about 97.3%, from about 97 to about 98%, from about 98 to about 99.8%, from about 99.5 to about 100% of the water activity of a natural egg.

Thickening Properties

Eggs are commonly used as thickening agents for a number of food products such as sauces, custards, and fillings. Thickening can be caused by the physical interference of water molecules in the food product with molecules from the thickening product. Thickening properties of a food product prepared from ESC may be indicated by the ability to thicken the ESC containing product to the desired amount in a smooth, consistent manner, while minimizing the formation of lumps. In some embodiments, the ESC may provide thickening properties. In some embodiments, the ESCs may provide from about 1 to about 30%, about 20 to about 50%, about 30 to about 70%, about 40 to about 90%, about 60 to about 100% of the thickening properties of a natural egg.

Leavening Properties

Eggs provide leavening properties that are useful in a number of cooking and non-cooking applications. A leavening agent can have foaming action that introduces air bubbles into the product, and can be used to provide height, lightening, and fluffiness of the finished product. For example, eggs are commonly used in cake, bread, muffin, soufflé, and other recipes to impart a fluffy texture to the final product. Leavening properties of an egg or ESC may be indicated by the height and texture of the final product. For example, a light, airy texture indicates superior leavening compared to a heavy, gummy texture. In some embodiments, the ESCs can provide leavening properties similar to that of natural eggs. In some embodiments, the ESC has from about 1 to about 30%, about 20 to about 50%, about 30 to about 70%, about 40 to about 90%, about 60 to about 100% of the leavening properties of a natural egg. Leavening properties may be evaluated indirectly through other parameters, including, density, height, resilience, and lateral expansion of the finished food product.

Emulsifying Properties

The emulsifying properties of natural eggs are useful in the preparation of food products that require the mixing and integration of substances that are immiscible, such as oil and water. Many products for human consumption are oil-in-water emulsions, including but not limited to hollandaise sauces and mayonnaise. In oil-in-water emulsions, oil droplets are dispersed evenly throughout an aqueous phase. However, oil droplets will tend to coalesce over time. An emulsifying agent can minimize the coalescence of the oil droplets, resulting in a smooth, creamy mixture. The emulsifying properties of the present ESCs may be determined by the texture, consistency, and stability of the food product, e.g., a sauce. For example, a sauce that remains smooth indicates a superior emulsion compared to a sauce that has undergone partial or complete separation over time. In some embodiments, the ESC may provide emulsifying properties. In some embodiments, the ESC has from about 1 to about 30%, about 20 to about 50%, about 30 to about 70%, about 40 to about 90%, about 60 to about 100% of the emulsifying properties of a natural egg.

Sensory Properties of the ESCs

Mouth-feel (or “Sensory Test”) is a concept used in the testing and description of food products. Products made using the ESCs of the present invention may be assessed for mouth-feel. In some embodiments products, e.g., baked goods, made using ESCs of the present invention have mouth-feel that is similar or superior to products made with natural eggs.

Exemplary properties which may be included in a measure of mouth-feel include, but are not limited to, (a) Cohesiveness: the degree to which the sample deforms before rupturing when biting with molars; (b) Density: the compactness of a cross section of the sample after biting completely through with the molars; (c) Dryness: the degree to which the sample feels dry in the mouth; (e) Fracturability: the force with which the sample crumbles, cracks or shatters, and it encompasses crumbliness, crispiness, crunchiness and brittleness; (f) Graininess: the degree to which a sample contains small grainy particles, which may be seen as the opposite of smoothness; (g) Gumminess: the energy required to disintegrate a semi-solid food to a state ready for swallowing; (h) Hardness: the force required to deform the product to given distance, i.e., force to compress between molars, bite through with incisors, compress between tongue and palate; (i) Heaviness: the weight of product perceived when first placed on tongue; (j) Moisture absorption: the amount of saliva absorbed by product; (k) Moisture release: the amount of wetness/juiciness released from sample; (l) Mouth-coating: the type and degree of coating in the mouth after mastication (for example, fat/oil); Roughness: Degree of abrasiveness of product's surface perceived by the tongue; (m) Slipperiness: the degree to which the product slides over the tongue; (n) Smoothness: the absence of any particles, lumps, bumps, etc., in the product; (o) Uniformity: the degree to which the sample is even throughout; homogeneity; (p) Uniformity of Bite: the evenness of force through bite; (q) Uniformity of Chew: the degree to which the chewing characteristics of the product are even throughout mastication; (r) Viscosity: the force required to draw a liquid from a spoon over the tongue; and (s) Wetness: the amount of moisture perceived on product's surface.

In exemplary embodiments, food products made with ESCs embodying features of the present invention showed no significant difference as compared to those made with fresh eggs.

Storage and Shelf Life

Eggs and products made from eggs have a limited shelf life. Raw eggs in the shells should only be stored with refrigeration for up to 5 weeks. When the yolk or the white are removed from the shell the storage life with refrigeration drops to only a maximum of 4 days. Commercially available non-sterile liquid egg substitutes also have a limited shelf life of up to about 7 days in the refrigerator. Similarly foods cooked with eggs have a limited storage life. A pie or a quiche cooked with eggs should only be stored for less than a week with refrigeration.

ESCs of the invention may provide significant gains in shelf life, for both the egg substitute and for food products produced using the egg substitute. ESCs of the invention may, in some embodiments, be stable in storage at room temperature for up to 1, 2, 3, 4, 5, 6, 7, 8, 9, 10 weeks or months.

Reconstituting from a Dry ESC

In some embodiments the ESCs are reconstituted with a liquid, e.g. water, milk, or other liquid suitable for human consumption or use, as a FESC. In one example about 36 to about 45 g of liquid (e.g., water or milk) can be added to about 12 to about 15 g dry weight of the ESC to produce a substitute for 1 whole egg. The amount of liquid can be varied to suit a particular purpose for the reconstituted ESC. More or less liquid may further be added (or not) to provide mixtures having different viscosity characteristics that may be suitable as a ready to use mixture. By way of example and not limitation, a reconstituted ESC may be used as a “ready for use” pancake mix.

Below are exemplary formulations for reconstituting ESCs for some “Ready for use” applications: Omelets and waffles: about 1 part (by weight) of ESC to about 5.8 to about 6.2 parts (by weight) of water; Custard: about 1 part of ESC to about 5.6 to about 7.5 parts of water; Mayonnaise dressing: about 1 part of ESC to about 50 to about 80 parts of water; Sponge Cake: about 1 part of ESC to about 5.5 to about 6.16 parts of water; Muffins: about 1 part of ESC to about 8 to about 9 parts of water; Pound cake: about 1 part of ESC to about 8 to about 10 parts of water; Hot cakes: about 1 part of ESC to about 16 about 25 parts of water.

Food Products

In some embodiments, the invention provides a food product prepared using the ESCs described herein. In some cases, the food product is a baked food product (e.g., cookies, brownies, cake), a viscous liquid or semi-solid (e.g., sauce, dressing, custard), scramble, omelet, quiche, ice cream, pasta, meatloaf, or an emulsion (e.g. mayonnaise or dressings) food product.

Sensory Analysis and Evaluation

Examples

The following food products were made, each comprising one sample made from each of fresh natural eggs (“Reference” or “A” sample), ESC (“NOT-A Sample”): Omelet, custard, mayonnaise dressing, sponge cake, muffins, pound cake, and hot cakes. Each food product was prepared according to a recipe that was the substantially the same (except for the use of natural eggs versus ESC). Each food product was then subjected to the “A”-“NOT A” TEST as described below and results were complied for the Day 1 and Day 3 tests. The number of panelists in each case was at least 8.

Discrimination tests are some of the most common methods employed in sensory science. They are used to determine if a difference (or similarity) exists between two or more samples. Statistical significance testing is used to analyze the data and determine whether samples are deemed to be different or similar. These are often used when the samples are considered to be “confusable,” i.e. their differences are not obvious but need to be investigated.

The “A”-“not A” Test, according to the protocols established by ISO 8588:1987, is used to determine whether test samples in a series are the same as or different from the reference sample. The test is especially useful where triangle and duo-trio tests cannot be used. This may useful in many instances, for example, when comparisons are desired between products that have a strong or lingering flavor/aftertaste when you desire to control the time between sample presentations or if there are differences in appearance. It is also useful to determine assessor/s (or panelist/s) sensitivity to a stimulus.

Initially, panelists are presented with a reference sample, in this case a sample food product made with fresh natural eggs (REFERENCE OR “A” SAMPLE). Panelist are also presented with an “explicit” “A” sample to become familiar with the taste of a sample prepared with natural eggs. This “explicitly identified” “A” sample is no longer available to the panelist once the actual evaluation starts. The panelist is then presented, in a blind test format (or double blind) with a series of test samples, some of which are “A Sample” (unbeknownst to the panelist) and some are “NOT-A” samples. The panelist does not have access to the initial reference (made from natural fresh eggs) or the “explicitly identified” “A” sample while evaluating the various food product samples.

The panelist must determine whether the test sample is the same or different as compared to the initial “explicitly identified” “A” reference sample, thus forcing a choice. Only one type of “NOT-A” sample exists per test series. The samples are presented randomly with 3-digit codes (not discernable by the panelist as to the identify of the content) and one at time (an assessment is made and recorded before proceeding to the next sample). All samples are prepared in an identical way and representative of the product.

The panelists during their evaluation are asked to evaluate the samples for a number of mouth-feel effects including: color, appearance, texture, odor, taste, aroma, and trigeminal feelings; and to render a single comprehensive feedback.

According to the nature of the sample, and in order to avoid certain interfering effects of sensory adaptation, the same time interval was observed between the presentations of the two successive samples.

The test was conducted on Day 1 and repeated on Day 3 (two days later).

The total number of responses for “A” and “NOT-A” were tallied for each sample presentation. The chi-squared test (X̂2) was used to compare the different sample presentations and their responses. When calculating by hand, the X̂2 statistic was compared to a statistical table that shows the minimum value required before it can be concluded that a significant difference exist between the samples. A significance level (typically 5%) was also specified.

Materials for conducting the test included: trays, serving plates, distilled water, score sheets, master sheet, samples, spitting cups, toothpicks, small containers.

Omelet

Omelet samples were made according to the following recipe shown in TABLE III and prepared as below:

TABLE III

| | |
|---|---|
| “A” | “NOT-A” |

| INGREDIENTS | % | g | % | g |
|---|---|---|---|---|
| Fresh egg | 100 | 97 | 0 | 0 |
| ESC | 0 | 0 | 15 | 14 |
| Water | 0 | 0 | 85 | 83 |
| Total | 100 | 97 | 100 | 97 |

Preparation of Reference Sample:
Mix two fresh eggs well;
Pour into a skillet and cook, each side, for 35 seconds.

Preparation of “A” Sample
Mix two fresh eggs well;
Pour into a skillet and cook, each side, for 35 seconds.

Preparation of “not-A” Sample
Add 14 grams (g) ESC to 83 milliliters (ml) of water;
Mix thoroughly, yielding approximately 97 g of liquid “NOT-A” sample (equivalent to 2 natural eggs);
Pour into a skillet and cook, each side, in a skillet for 35 seconds.

Preparation of the Omelet Test Samples

Sufficient quantity of each sample was provided enough to make 4 g of food product. Samples were presented in identical containers (3.8×4.0 cm). Sample containers were coded using randomly chosen unique 3 digit codes, unidentifiable as to their source to the panelist. The samples were tested by the panelists according to the “A Test” as described above. After the results of the Day 1 and Day 3 were accumulated, they were analyzed. Results did not yield any statistically significant difference between the “A” and “not A” samples.

Custard

Custard samples were made according to the recipe shown in TABLE IV and prepared as below:

TABLE IV

| | “A” | “NOT-A” |
|---|---|---|
| INGREDIENTS | % | % |
| Evaporated milk | 32.4 | 32.4 |
| Condensed milk | 34.0 | 34.0 |
| Cream cheese | 16.3 | 16.3 |
| Fresh egg | 17.1 | 0 |
| ESC | 0 | 2.6 |
| Water | 0 | 14.5 |
| Vanilla flavor | 0.2 | 0.2 |
| Total | 100.0 | 100.0 |

Preparation of Reference Sample
Mix all ingredients;
Add the percentage of milk or water required;
Mix until a smooth paste is obtained;
Cook in a suitable container for about 45 to 60 minutes at about 190° C.;
Let cool for about 1 hour.

Preparation of “A” Sample
Mix all ingredients;
Add the percentage of milk or water required;
Mix until a smooth paste is obtained;
Cook in a suitable container for about 45 to 60 minutes at about 190° C.;
Let cool for about 1 hour.

Preparation of “not-A” Sample
Mix all ingredients including the ESC;
Add the percentage of milk or water required;
Mix until a smooth paste is obtained;
Cook in a suitable container for about 45 to 60 minutes at 190° C.;
Let cool for about 1 hour.

Preparation of the Custard Test Samples

Sufficient quantity of each sample was provided enough to make 7 grams of food product. Samples were presented in identical containers (3.8×4.0 cm). Sample containers were coded using randomly chosen unique 3 digit codes, unidentifiable as to their source to the panelist. The samples were tested by the panelists according to the “A Test” as described above. After the results of the Day 1 and Day 3 were accumulated, they were analyzed. Results did not yield any statistically significant difference between the “A” and “not A” samples.

Mayonnaise Dressing

Mayonnaise dressing samples were made according to the following shown in TABLE V and prepared as below:

TABLE V

| | “A” | “NOT A” |
|---|---|---|
| INGREDIENTS | % | % |
| Water | 34.06 | 40.56 |
| Oil | 35.00 | 35.00 |
| Vinegar 5% | 13.00 | 13.00 |
| Salt | 1.26 | 1.26 |
| Sugar | 1.58 | 1.58 |
| Potassium sorbate | 0.15 | 0.15 |
| Sodium benzoate | 0.15 | 0.15 |
| Fresh egg | 7.00 | 0.00 |
| ESC | 0.00 | 0.50 |
| Lemon powder | 0.30 | 0.30 |
| Skimmed milk powder | 2.00 | 2.00 |
| Profit cf | 0.20 | 0.20 |
| Dynagel | 4.50 | 4.50 |
| Mustard | 0.80 | 0.80 |
| Total | 100.00 | 100.00 |

Preparation of Reference Sample
Mix fresh eggs, salt, sugar, and preservatives in 20% of the water (see ingredient list) to prepare a dispersion (“dispersion”);
Add skim milk powder to the remainder of the water (aqueous phase);
Add the oil to the aqueous phase of step above and shake well;
Add the dispersion to the mix above;
Add vinegar and lemon powder to the mix above and shake well.

Preparation of “A” Sample
Mix fresh eggs, salt, sugar, and preservatives in 20% of the water (see ingredient list) to prepare a dispersion (“dispersion”);
Add skim milk powder to the remainder of the water (aqueous phase);
Add the oil to the aqueous phase of step above and shake well;
Add the dispersion to the mix above;
Add vinegar and lemon powder to the mix above and shake well.

Preparation of “not-A” Sample
Mix ESC, salt, sugar, and preservatives in 20% of the water (see ingredient list) to prepare a dispersion (“dispersion”);
Add skim milk powder to the remainder of the water (aqueous phase);
Add the oil to the aqueous phase of step above and shake well;
Add the dispersion to the mix above;
Add vinegar and lemon powder to the mix above and shake well.

Preparation of the Mayonnaise Dressing Test Samples

Sufficient quantity of each sample was provided enough to make 2 grams of food product. Samples were presented in identical containers (3.8×4.0 cm). Sample containers were coded using randomly chosen unique 3 digit codes, unidentifiable as to their source to the panelist. The samples were tested by the panelists according to the “A Test” as described above. After the results of the Day 1 and Day 3 were accumulated, they were analyzed. Results did not yield any statistically significant difference between the “A” and “not A” samples.

Sponge Cake

Sponge cake samples were made according to the following shown in TABLE VI and prepared as below:

TABLE VI

| | “A” | “NOT A” |
|---|---|---|
| INGREDIENTS | % | % |
| Sponge premix | 50 | 50 |
| Water | 15 | 43 |
| Fresh egg | 35 | 0 |
| ESC | 0 | 7 |
| Total | 100 | 100 |

Sponge Cake Preparation

Preparation of Reference Sample
Mix the ingredients at a slow speed with a flat beater for about 8 minutes;
Fill the baking molds with 500-900 gram of batter;
Bake at a temperature of approximately 170 to about 190° C. for about 40 to about 50 minutes.
Let cool.

Preparation of “A” Sample
Mix the ingredients at a slow speed with a flat beater for about 8 minutes;
Fill the baking molds with 500-900 gram of batter;
Bake at a temperature of approximately 170 to about 190° C. for about 40 to about 50 minutes.

Preparation of “not-A” Sample
Mix the ingredients including the ESC at a slow speed with a flat beater for about 8 minutes;
Fill the baking molds with 500-900 gram of batter;
Bake at a temperature of approximately 170 to about 190° C. for about 40 to about 50 minutes.
Let cool.

Preparation of the Sponge Cake Test Samples

Sufficient quantity of each sample was provided enough to make 4 grams of samples was prepared. Sample containers were coded using randomly chosen unique 3 digit codes, unidentifiable as to their source to the panelist. The samples were tested by the panelists according to the “A Test” as described above. After the results of the Day 1 and Day 3 were accumulated, they were analyzed. Results did not yield any statistically significant difference between the “A” and “not A” samples.

Muffins

Muffin samples were made according to the following shown in TABLE VII and prepared as below:

TABLE VII

| | “A” | “NOT A” |
|---|---|---|
| INGREDIENTS | % | % |
| Vanilla premix | 52.63 | 52.63 |
| Water | 15.79 | 31.58 |
| Oil | 15.79 | 15.79 |
| Fresh egg | 15.79 | 0.00 |
| ESC | 0.00 | 3.16 |
| Total | 100.00 | 100.00 |

Muffins Preparation

Preparation of Reference Sample

Preparation of “A” Sample
Mix the ingredients with a flat beater for about 5 minutes;
Fill the muffins trays with about 65 gram of batter;
Bake at a temperature of approximately 180 to about 190° C. for about 25 to about 30 minutes;
Let cool.

Preparation of “not-A” Sample
Mix the ingredients including the ESC with a flat beater for about 5 minutes;
Fill the muffins trays with about 65 gram of batter;
Bake at a temperature of approximately 180 to about 190° C. for about 25 to about 30 minutes;
Let cool.

Preparation of the Muffin Test Samples

Sufficient quantity of each sample was provided enough to make 3 grams of samples was prepared. Sample containers were coded using randomly chosen unique 3 digit codes, unidentifiable as to their source to the panelist. The samples were tested by the panelists according to the “A Test” as described above. After the results of the Day 1 and Day 3 were accumulated, they were analyzed. Results did not yield any statistically significant difference between the “A” and “not A” samples.

Poundcake

Poundcake samples were made according to the following shown in TABLE VIII and prepared as below:

TABLE VIII

| | “A” | “NOT A” |
|---|---|---|
| INGREDIENTS | % | % |
| Fresh egg | 18.9 | 0.0 |
| ESC | 0.0 | 3.8 |
| Oil | 17.7 | 13.3 |
| Vanilla flavor | 1.4 | 1.4 |
| Wheat flour | 27.2 | 27.2 |
| Baking powder | 1.4 | 1.4 |
| Water | 10.9 | 30.5 |
| Sugar | 22.6 | 22.6 |
| Total | 100.0 | 100.0 |

Poundcake Preparation

Preparation of Reference Sample
Mix the fresh eggs and sugar for about 3 minutes with an egg beater;
Mix the ingredients including oil, water, vanilla, flour, baking powder for about 2 minutes at a low speed with a flat beater;
Scrape the bottom of the bowl to incorporate the mixture;
Mix the mixture at high speed for about 7 minutes;
Fill the molds with about 500 to about 900 gram of batter;
Bake at about 195° C. for about 38 to about 42 minutes;
Let cool.

Preparation of “A” Sample
Mix the fresh eggs and sugar for about 3 minutes with an egg beater;
Mix the ingredients including oil, water, vanilla, flour, baking powder for about 2 minutes at a low speed with a flat beater;
Scrape the bottom of the bowl to incorporate the mixture;
Mix the mixture at high speed for about 7 minutes;
Fill the molds with about 500 to about 900 gram of batter;
Bake at about 195° C. for about 38 to about 42 minutes;
Let cool.

Preparation of “not-A” Sample
Mix the ingredients including oil, water, vanilla, sugar, flour, baking powder and ESC for about 3 minutes with an egg beater;
Mix the ingredients including oil, water, vanilla, flour, baking powder for about 2 minutes at a low speed with a flat beater;
Scrape the bottom of the bowl to incorporate the mixture;
Mix the mixture at high speed for about 7 minutes;
Fill the molds with about 500 to about 900 gram of batter;
Bake at about 195° C. for about 38 to about 42 minutes;
Let cool.

Preparation of the Poundcake Test Samples

Sample containers were coded using randomly chosen unique 3 digit codes, unidentifiable as to their source to the panelist. The samples were tested by the panelists according to the “A Test” as described above. After the results of the Day 1 and Day 3 were accumulated, they were analyzed. Results did not yield any statistically significant difference between the A and “not A” samples.

Hot Cakes

Hot cake samples were made according to the following shown in TABLE IX and prepared as below:

Formulation:

TABLE IX

| | “A” | “NOT A” |
|---|---|---|
| INGREDIENTS | % | % |
| Hot cakes premix | 36.1 | 36.1 |
| Milk | 47.2 | 47.2 |
| Water | 0.0 | 11.1 |
| Fresh egg | 13.9 | 0.0 |
| ESC | 0.0 | 2.8 |
| Butter | 2.8 | 2.8 |
| Total | 100.0 | 100.0 |

Hot Cakes Preparation:

Reference

Preparation of “A” Sample
Mix all ingredients until a smooth batter is formed;
Heat a kitchen skillet on medium to medium high heat;
Place a pat of butter (see ingredients) in the skillet and when butters starts to sizzle, pour the batter into the skillet forming cakes in any desired size;
Turn over hot cakes when they start to bubble;
Remove the hot cakes when the other side is a light brown color;
Repeat until you use all of the batter;
Serve with butter and syrup.

Preparation of “not-A” Sample
Mix all ingredients including the ESC until a smooth batter is formed;
Heat a kitchen skillet on medium to medium high heat;
Place a pat of butter (see ingredients) in the skillet and when butters starts to sizzle, pour the batter into the skillet forming cakes in any desired size;
Turn over hot cakes when they start to bubble;
Remove the hot cakes when the other side is a light brown color;
Repeat until you use all of the batter;
Serve with butter and syrup.

Preparation of the Hot Cake Test Samples

Sufficient quantity of each sample was provided enough to make 3 grams of samples was prepared. Sample containers were coded using randomly chosen unique 3 digit codes, unidentifiable as to their source to the panelist. The samples were tested by the panelists according to the “A Test” as described above. After the results of the Day 1 and Day 3 were accumulated, they were analyzed. Results did not yield any statistically significant difference between the “A” and “not A” samples.

Method of Making ESCs

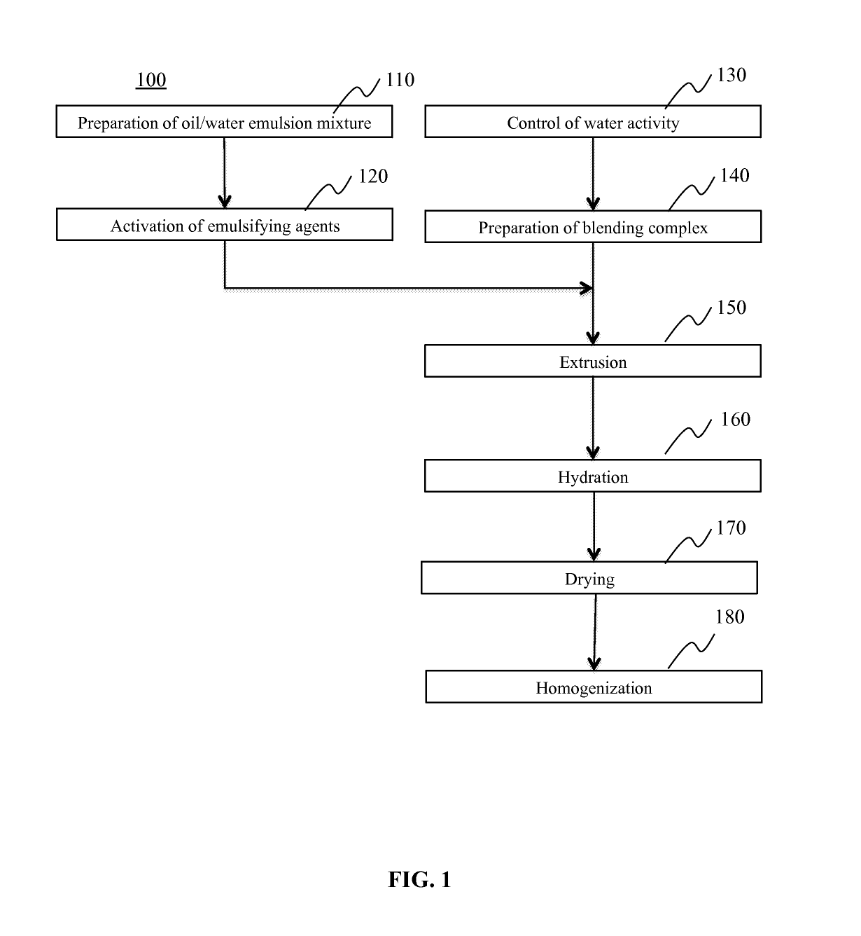

An exemplary method 100 embodying features of the present invention for preparing the ESCs of the present invention may include a plurality of stages as shown in FIG. 1, including stage 110 for preparing of an oil/water emulsion, stage 120 for activation of emulsifying agents, stage 130 for retention of moisture through control of water activity, stage 140 for preparation of blending complex, stage 150 for extrusion process, and stage 160 yielding hydrated ESC; optional stage 170 for drying the mixture to yield ESC, and stage 180 for homogenization.

The various mixtures and ingredients used in the processes of making the ESC of present invention are designed to yield ESCs embodying features of the present invention. Exemplary formulation and ingredients, useable in processes of making the ESCs, are described in TABLE X:

TABLE X

| ESC | % |
|---|---|
| Vegetable and animal protein concentrate | 25.00-60.00 |
| Wheat, rice and potato starch | 15.00-45.00 |
| Vegetable fat | 0.25-25.00 |
| Stabilizer agents | 0.50-10.00 |
| Emulsifier agents | 0.25-8.00 |
| Vegetable microfibers | 1.00-8.00 |
| Mineral salts | 0.02-2.50 |
| Citric acid | 0.25-2.00 |
| Enzymes | 0.01-0.08 |

Exemplary ingredients in addition to those described above may include: vegetable and/or animal protein concentrate comprising: whey protein, soy protein, pea protein, bean protein, chick pea protein, wheat protein, sodium caseinate, casein, lactoglobulin, lactalbumin, seroalbumin, and combinations thereof; vegetable oil comprising: soybean oil, cotton oil, coconut oil, vegetable oils of non-lauric origin, fractions palm half, and combinations thereof; stabilizers comprising: sodium alginate, xantham gum, carrageenan, sodium carboxymethylcellulose, and combinations thereof; emulsifiers comprising: lactic acid esters, soy lecithin, hydrolyzed lecithin, polyglycerol poly ricinoleate, lactic acid esters of mono and diglycerides, and combinations thereof; vegetable microfibers comprising: wheat microfiber, oat microfiber, bamboo microfiber, apple microfiber, and combinations thereof; mineral salts comprising: calcium phosphate, magnesium carbonate, magnesium phosphate, sodium carbonate, and combinations thereof; enzymes comprising: bromelein, amylase, protease, and combinations thereof.

In an embodiment, and as shown in FIG. 1, an exemplary method 100 for preparation of ESC of the present invention includes the following general stages: An oil/water emulsion mixture is prepared (stage 110) which may be used as a bonding film. In stage 120 emulsifying agents are activated. Water activity is controlled in stage 130 to retain moisture. In stage 140 a blending complex is prepared including proteins, carbohydrates, soluble fiber, mineral salts, and enzymes. The prepared mixture is extruded in stage 150 yielding a hydrated homogenized mix of stage 160 (e.g., for hydrated ESC). To obtain dry ESC (e.g., powdered form ESC), the hydrated mixture of stage 160 is dried in stage 170. In Stage 180, the mixture is homogenized.

Hydration affects the structure of protein crystals. For example, when proteins are completely or substantially dehydrated, the crystalline structure may disintegrate. Thus, in order to maintain moisture in the protein mass of the ESC, a coating may be applied as a thin film to the solid protein particles. This may also allow for the later expansion of the protein through increased hydrogen bonding. It is believed, without intending to limit the scope of the present invention, that preparation of an oil/water emulsion is beneficial in the process of making the ESCs in order to form a thin uniform and temperature resistant film for coating the solid protein particles. It is further believed that such a formation aids in retention of moisture in each particle thus achieving the expansion of the protein particles upon re-hydration during use.

Activation of the emulsifying agents (stage 120) reduces the size of the fat globules to yield ESCs with fisicomimetic characteristics (e.g. substances that mimic the physical and organoleptic properties) similar to those of fresh eggs.

Emulsions are thermodynamically unstable mixtures of immiscible liquids. Emulsified droplets can be stabilized by the addition of molecules that are partially soluble in both phases. In food materials, such as egg products, a number of small emulsifier molecules are used to provide the stability for the emulsion. Proteins capable of unfolding at the interface may serve this function. Using this method, the protein coats the lipid droplet and provides an energy barrier to particle association and phase separation according to the relationship known as Stokes' Law. Upon the input of energy into this system through mixing conditions, the physical nature of the molecules being mixed is altered. This has the net effect of decreasing the average fat globule size and alters the conformation of the protein molecule.

In some embodiments, the emulsifying agents are activated utilizing a high-pressure homogenization system under suitable pressure, typically ranging from about 500 to about 2500 lb/in².

The activation enables suitable reduction in size of the fat globules to obtain the physiochemical characteristics of fresh eggs. This may aid in the activation of the added emulsifiers that aid in yielding a stable oil-in-water emulsion that is ready for further processing.

Protein structure is highly dependent on the environment and the protein will assume different conformations as the environmental conditions change, which causes a thermodynamic change in the protein molecule (e.g. changes in free energy). One method to decrease the free energy is through control of water activity and retention of moisture through the hydration of mineral salts. This typically creates: 1) a hydrogen bond network among the protein molecules generating electrostatic bonds among the positive and negative polarities throughout the protein molecules (e.g., water is thus bonded physicochemically within the protein structure), 2) the addition of hydrated minerals distributes a uniform thin layer of water within the protein structure, which obtains products with improved organoleptic and sensory quality and quantity, 3) the added mineral salts react chemically converting the bulk of the structure to an anhydrous system by means of hydrolysis of phosphate or carbonate mineral salts typically breaking up of a chain by water molecules forming a progressive and generally irreversible capture of water molecules. An exemplary embodiment is shown in FORMULA I where a chain of phosphate (e.g., about six or more molecules phosphate) in the presence of water is divided in half (hydrolysis occurs in the middle of the chain).

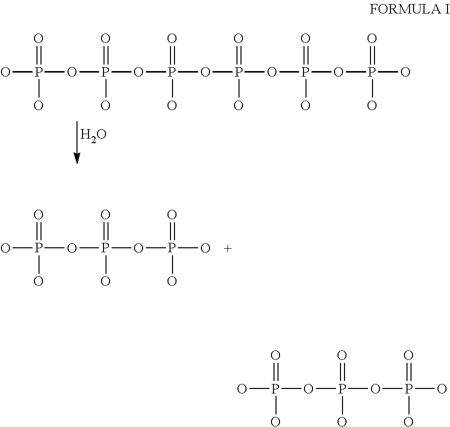

After hydrolysis, a physicochemical reaction is initiated through adding water, catalyst, heat and buffer salts. The reaction is controlled by temperature and pH, causing the hydrolysis to start at the beginning of the chain that induces the formation of orthophosphates capturing water as shown in FORMULA II.

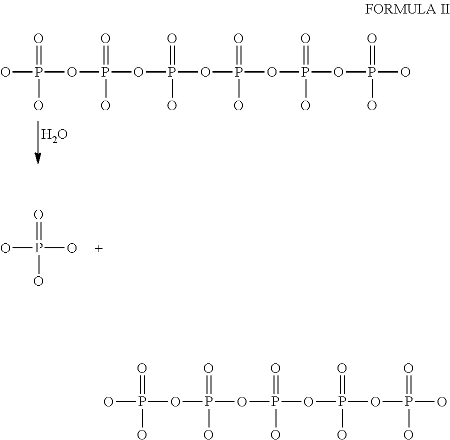

Finally the combination of phosphate, pyrophosphate and hexametaphosphate, and the addition of catalysts, heat, salts buffer (controlled by pH and temperature) will obtain an ORTHO system, which is progressive and generally irreversible as shown in FORMULA III.

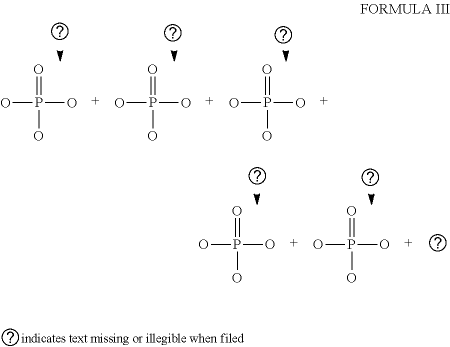 [SMILES: O=P(O)(O)O ; O=P(O)(O)O ; O=P(O)(O)O ; O=P(O)(O)O ; O=P(O)(O)O]

As herein described, it is believed that the benefits of applying hydrating minerals to the anhydrous protein complex may include, but not limited to: a) increased equivalence of ESC hydration ranging from a ratio of about 1:4 to about 1:6 (ESC part: parts Water; b) improved retention of steam during the cooking process; 3) increased shelf life, avoiding bacterial contamination despite the high moisture content in the formulation.

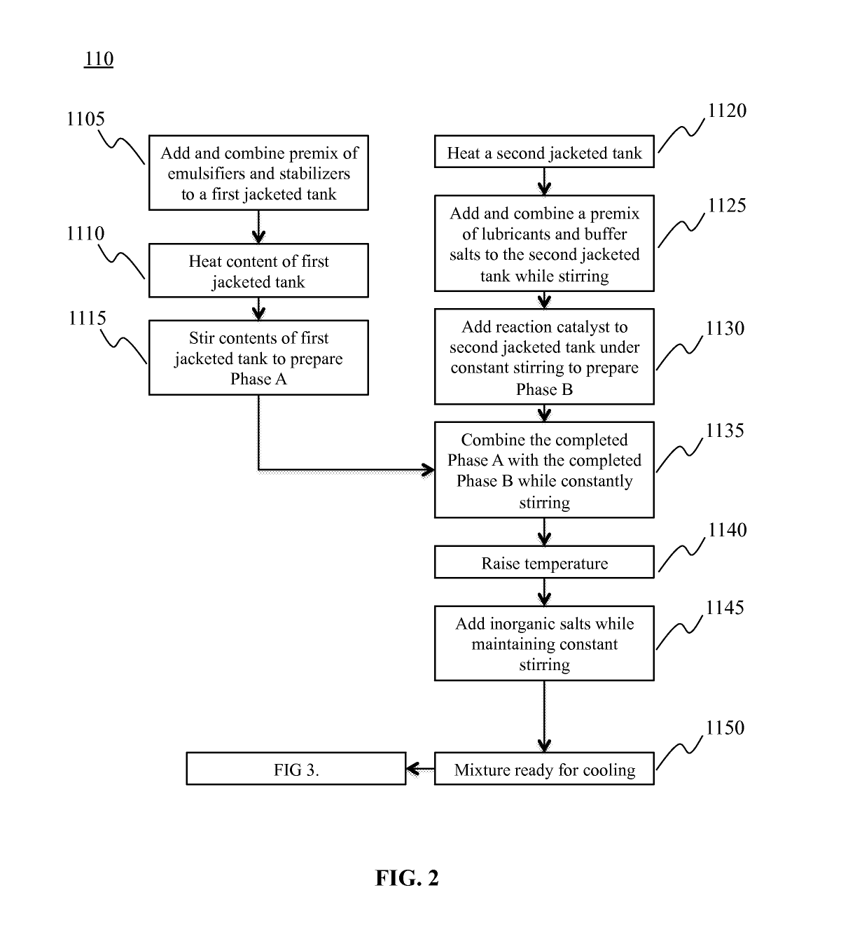

Now referring to FIGS. 2, 3 and 4, steps for performing stages 110, 120, and 130 will be discussed below in more detail.

The oil/water emulsion of step 110 (FIG. 2) may be prepared as follows: Two phases A and B are prepared and thereafter mixed together to yield the oil/water emulsion.

Preparation of Fat (Oil Phase) Phase A:

In step 1105, a premix of emulsifiers and stabilizers is added to a first jacketed tank. An exemplary premix may be formulated as follows: emulsifiers, from about 0.25% to about 8% by weight (of solids) comprising one or more of lactic acid esters, soy lecithin, hydrolyzed lecithin, polyglycerol polyricinoleate, lactic acid esters of mono and diglycerides; and stabilizers, from about 0.5 to about 10% by weight (of solids) comprising one or more of sodium alginate, xanthan gum, carrageenan, and sodium carboxymethylcellulose.

In step 1110 temperature of the premix of step 1105 is brought to a suitable temperature, typically ranging from about 80 to about 95° C. Typically the premix is continuously stirred at a suitable speed, typically ranging from 55 to about 70 Hz.

In step 1115, the stirring of pre-mix of step 1110 at a suitable speed is continued, typically at a speed ranging from 55 to about 70 Hz, for suitable period of time, typically ranging from about 50 to about 120 minutes.

Preparation of Water (Aqueous Phase) Phase B:

In step 1120, water is added to a second jacketed tank and heated to a suitable temperature, typically ranging from about 40 to about 90° C.

In step 1125, a premix of lubricants and buffer salts is combined while stirring at suitable speed, typically ranging from about 55 to about 70 Hz for suitable length of time, typically ranging from about 15 to about 30 minutes. Catalyst is added to the tank under constant stirring, in Step 1130, yielding Phase B.

In step 1135, the completed Phase A (from step 1115) is added to and combined with the completed Phase B (from step 1130) while constantly stirring the mix at a suitable speed, typically ranging from about 55 to about 70 Hz.

In step 1140, the temperature is raised to a suitable temperature, typically ranging from about 80 to about 95° C., while stirring.

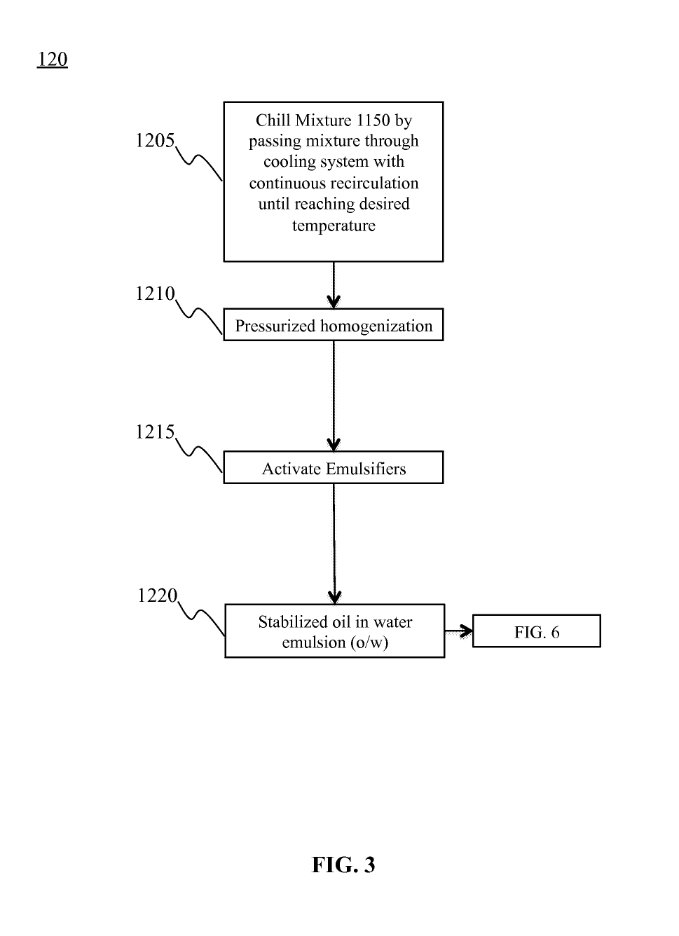

In step 1145, inorganic salts are added while maintaining constant stirring at a suitable speed, typically ranging from about 55 to about 70 Hz. This creates a mixture 1150 ready for cooling in step 1205 (FIG. 3).

Now referring to FIG. 3 and stage 120, the mixture from step 1150 is passed through a cooling system at step 1205 with continuous recirculation until reaching a suitable temperature, typically about 25° C. The mixture is further homogenized at step 1210 by subjecting the mixture to a high pressure under suitable pressure, typically ranging from about 500 to about 2500 lb/in² for a suitable length of time, typically ranging from about 20 to about 45 minutes. The high-pressure homogenization reduces the size of the fat globules (e.g., about 1 to about 3 microns) imparting more egg like properties onto the ESCs.

At step 1215 the emulsifiers are activated. The activation enables suitable reduction in size of the fat globules to obtain the physiochemical characteristics of fresh eggs. This may aid in the activation of the added emulsifiers that aid in yielding a stable o/w of step 1220 that is ready for further processing.

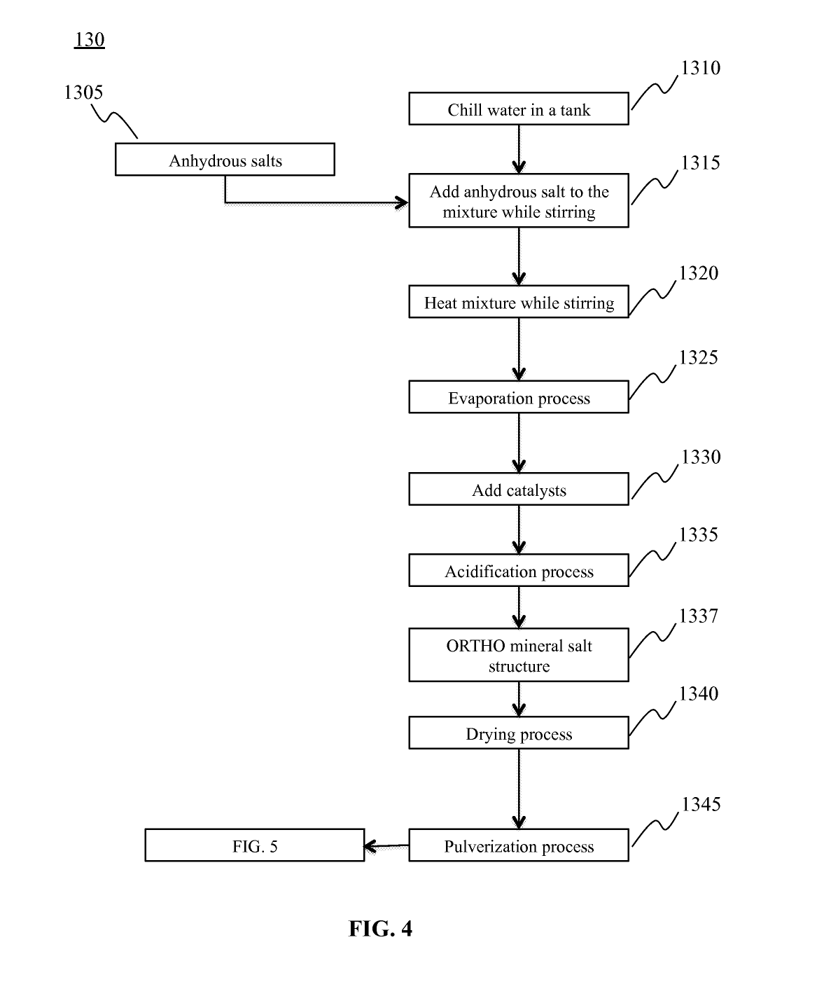

Now referring to FIG. 4 and stage 130, moisture retention and effective control of water activity is achieved through the hydration of mineral salts (which aid in the binding of water molecules, thus hydration, of the particles).

A mixture (about 10 to about 30% by total weight) of anhydrous salts (e.g., any one or more of calcium phosphate, magnesium carbonate, magnesium carbonate and sodium phosphate) is prepared in step 1305. Water (about 70 to about 90% by total weight) is chilled to about 4° C. by a cooling chiller in a tank at step 1310. Anhydrous salts are added to the tank while stirring at step 1315. The mixture is heated to pasteurization temperatures ranging from about 70 to about 90° C. while stirring at a suitable speed, typically about 20 to 40 RPM, for a suitable period of time, typically ranging from about 20 to about 40 minutes at step 1320. At step 1325, the mixture is heated, to about 80 to about 100° C., to yield an at least partially evaporated mixture of about 70 to about 90%, typically 80% solids, total weight. Catalysts (one or more of calcium and magnesium catalysts to accelerate the reaction rate) are added (about 0.001 to about 0.005% total weight) to the mixture of step 1325 while stirring at step 1330. At step 1335 the supersaturated solution is acidified with phosphoric acid (about 0.05 to about 1% total weight) to a pH of about 3 to about 4, typically 3.5 (ortho minerals structure). At step 1340 the acidified mixture is subjected to a drying process with the addition of air at a temperature of about 115 to about 130° C., typically about 120° C. for about 30 minutes. At step 1345, the mineral salts are pulverized to a particle size of about 20 to about 30 micron using a milling process (about 5 to about 10 minutes) to an average particle size of about 20 to about 30 microns.

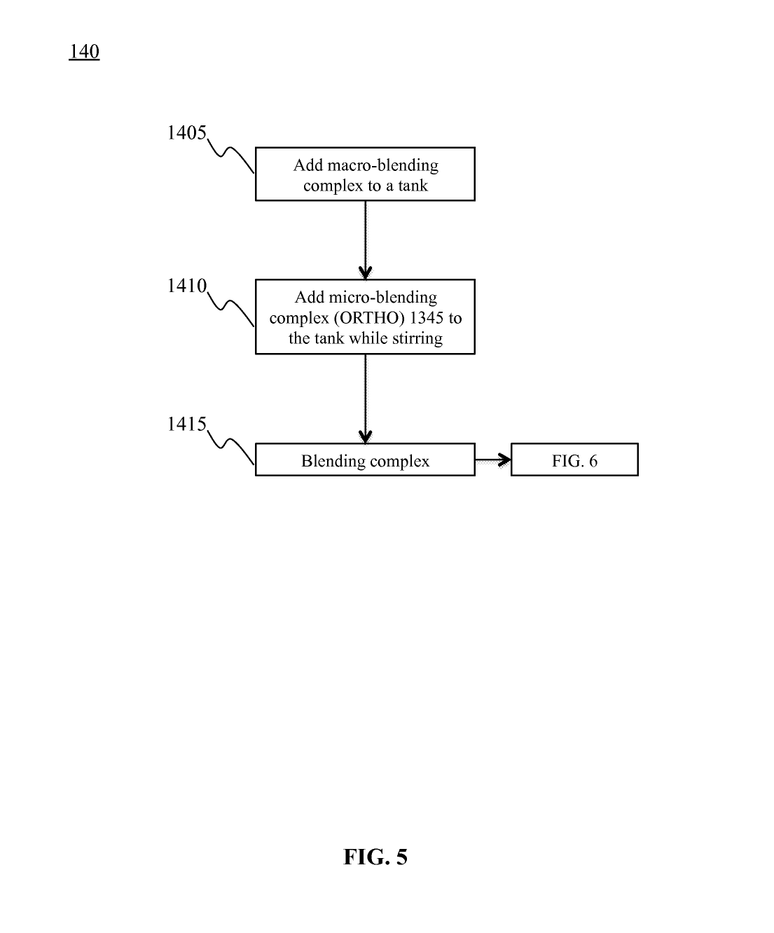

Now referring to FIG. 5, stage 140 for preparation of the blending complex is discussed below in more detail. Prior to the extrusion stage 150, the mixture including the micro and macro-ingredients is homogenized, preferably substantially homogenized.

In an embodiment, the preparation of the blending complex of stage 140 includes the following steps as follows. In step 1405, a mixture of macro-ingredients including protein, carbohydrates, and insoluble fiber is charged to a third tank, a blending tank, preferably a tank configured for temperature control (e.g., heating/cooling as in a jacketed tank). The mixture is stirred for about 20 to about 35 minutes typically at a speed of about 30 RPM.

In step 1410 a micro-ingredients complex 1345 (FIG. 4) including ortho salts (calcium phosphate, magnesium phosphate, diphosphate) is added to the mix of step 1405 and stirred for about 10 minutes.

In an embodiment, the blending tank is a helical ribbon blender. In an embodiment the blender is a conical twin-screw mixer with two asymmetric spiral cantilevers with different lengths. In an embodiment, in operation, the material of steps 1405 and 1410 are exposed to multi-directional (e.g., bi-directional) rotational and revolution mixing. In an embodiment, the two asymmetric spiral cantilevers rotate around one axis (rotation) (e.g., around the central axis of the cone-shaped container) while the rotary arms revolved in the cone near the wall (revolution; while the device repeatedly reverses materials through rotation and revolution enhancing the shear, convection and diffusion in the cone-shaped container generating the mixing. The jacket (heating, cooling) is added to control processing temperatures.

The mixture is further blended for about 30 to about 45 minutes with a stirring speed of about 30 RPM, yielding the blending complex of step 1415.

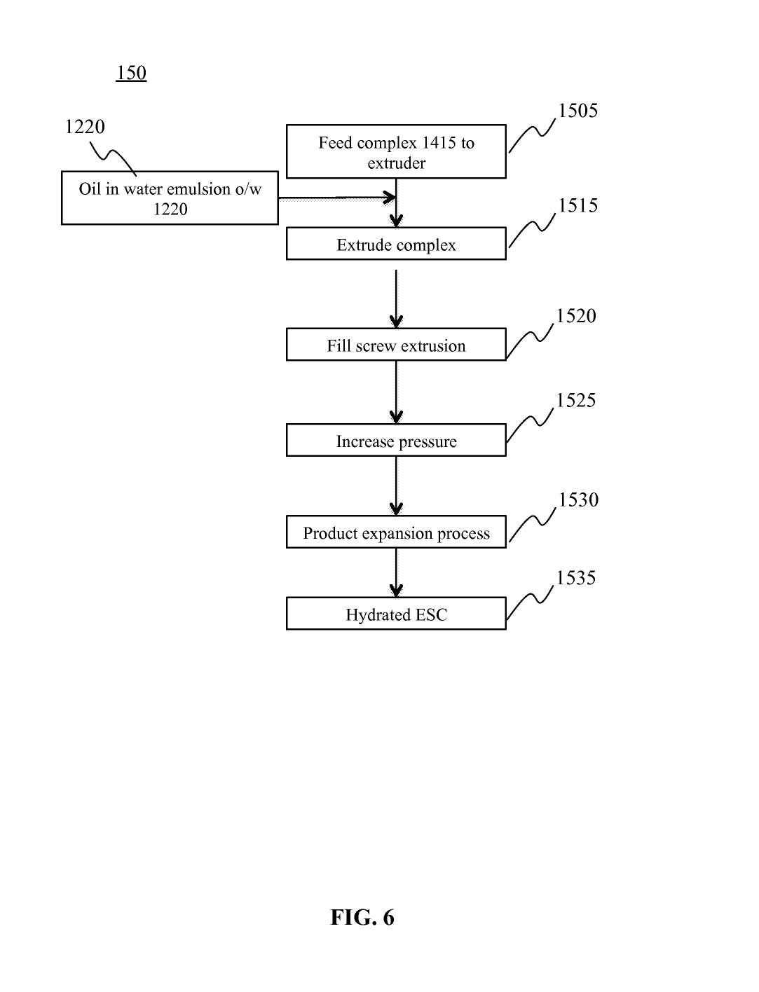

Now referring to FIG. 6, stage 150 the extrusion of the mixture is further described below. The extrusion stage creates compositions of a fixed, cross-sectional profile by pushing or drawing a material through a die of a desired cross-section. The material undergoes powerful compressive and shear stresses. The process has food applications by providing cooking, mixing and protein denaturation depending on inputs and parameters. In embodiments according to the process of the present invention, the extrusion aids in denaturing the protein complex to prepare it for final, marketable consumption.

An exemplary extruder useful in the processes according to the present invention, may include a feed cavity, multiple (e.g., four) temperature sections, a screw transporter, a pressure and temperature chamber and an output port; with a driving force element (e.g., a three-phase motor configured to deliver 100 HP, 440v, 60 Hz and 136 Amp).

The extrusion process aids, at least in part in the performance of any one or more of the following: 1) coating of solid particles through the adherent film; b) partial hydrolysis of protein and insoluble fiber; 3) enzymatic inactivation; 4) homogeneous dispersion of the emulsifying system; and 5) conditioning of the product for use as an food product comprising ESC.

In an exemplary embodiment, the extrusion stage 150, typically includes the following steps: In step 1505, the blending complex 1415 (from FIG. 5) is charged to a jacketed extruder at suitable seed or rate while maintaining the mixture at suitable temperature, typically ranging from about 20 to about 30° C. The oil in water emulsion of step 1220 (FIG. 3) is introduced into the extruder. In an exemplary embodiment, the oil in water emulsion is injected into the homogenized charge of the complex through a volumetric feeder (e.g., about 500 to about 1500 ml/sec) to moisten the mixture. The mixture is charged to a conveyor under pressure (e.g., pressure of about 40 to about 70 PSI), yielding an extruded complex at step 1515. The complex incorporated through the volumetric feeder at about 5 to 20 Hz fills the extruder screws at a speed of about 35 to about 40 Hz, which serve the function of kneading, compressing and holding temperature, with a greater speed (from about 50 to about 70 Hz) (compression) being exerted at step 1525 in order to modify the structure of the complex.

At step 1530 the extruded mixture (with a moisture content of about 18% to about 25%) exits through an exit port (e.g., a diameter ranging from about 2 to about 7 mm), yielding an expanded extruded mixture with a lower density with normalized moisture at step 1535. The mixture of step 1535 has a hydration ratio of about 1 to about 6.

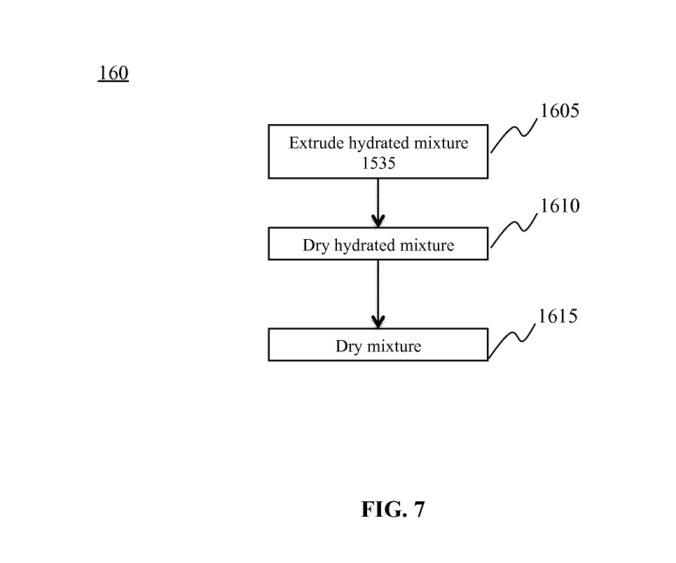

Now referring to FIG. 7 and stage 160, in order to yield a dry ESC, the hydrated mixture of step 1535 is dried in suitable dryer at suitable temperature, typically ranging from about 130 to about 140° C.; for a length of time, typically ranging from about 20 to about 30 min at step 1610. The dry ESC may have a moisture content ranging from about 3 to about 6%, resulting in dry mixture 1615.

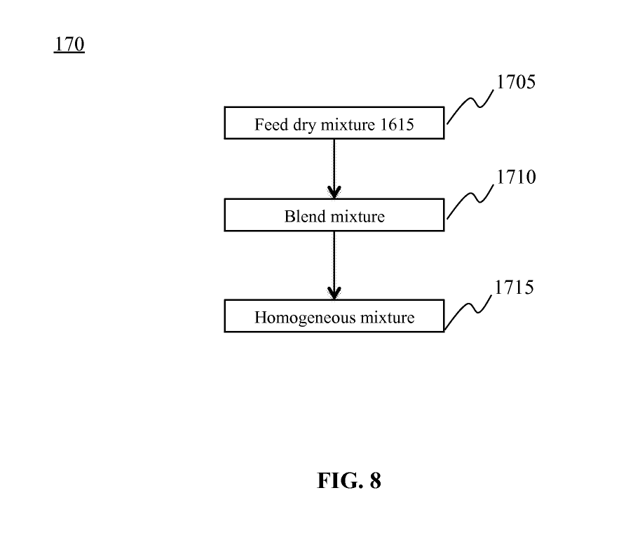

Now referring to FIG. 8 and stage 170, the dry mixture of step 1615 may further be homogenized by feeding the dry mixture to helical ribbon blender described above at step 1710, yielding a homogenized ESC at step 1715.

Testing of Finished Product (Texture Analysis)

As previously stated the ability of an egg or egg substitute to provide the desired moisture and fat to a product recipe (such as, for example, cake or bread recipes) may be indicated by the texture of the finished product. This texture analysis can be tested by instrumental analysis as well as in sensory analysis where human perception using the five senses are used to scientifically analyze reactions in a way that will create food characteristic categorizes. The latter is exemplified by the “A” and “Not-A” test described above. To further analyze using instrumental test methods, a Texture Analyzer may be used to perform Texture Profile Analysis (TPA). This test is an objective analysis primarily directed at the evaluation of mechanical characteristics where a material is subjected to a controlled force from which a deformation curve of its response is generated. The controlled force is generated from a vertical probe which is applied directly on to the food product. Depending on the foodstuff being tested, the probes can be cylindrical, conical, and spherical or even a needle.

The obtained deformation curves can then be used to create a profile of sensory characteristics based on the mechanical characteristics generated by the probe. These mechanical characteristics can be further sub-divided into primary and secondary sensory characteristics, which have technologically proven to be correlated to sensory perception. These sensorial mechanical parameters can be further sub-divided into primary and secondary characteristics. Primary characteristics include hardness, cohesiveness, elasticity and viscosity. Secondary characteristics include brittleness, chewiness and gumminess.

These deformation curves can then be statistically analyzed to determine if there is a statistical significant difference to other food material being evaluated. The texture analyzer used for the evaluation of ESCs embodying features of the present invention was a Brookfield Texture Analyzer manufactured by Brookfield Engineering Inc. The probe used was a TA 11/1000 Perspex (PMMA) cylinder having a diameter of 25.4 mm. This instrument with the probe was then utilized as a quality control instrument to measure the consistency in batches of the ESC. Furthermore, the texture analyzer was used to compare the deformation characteristics used in the “A” and “Not-A” Test as described above. The results were used for comparisons between a typical egg replacement and the ESC product. For example, the custard recipe produced the following deformation results as shown in TABLE XI:

TABLE XI

| CHARACTERISTIC | REFERENCE | ESC |
|---|---|---|
| Deformation | 6.7 | 6.6 |
| Hardness 1 (g) | 637.8 | 537.2 |
| Hardness 2 (g) | 565.6 | 439.3 |
| Cohesiveness | 0.61 | 0.59 |
| Springiness (mm) | 5.6 | 5.5 |
| Adhesion (mJ) | 1.05 | 1.49 |

The foregoing disclosure of the exemplary embodiments has been presented for purposes of illustration and description. It is not intended to be exhaustive or to limit the invention to the precise forms disclosed. Many variations and modifications of the embodiments described herein will be apparent to one of ordinary skill in the art in light of the above disclosure.

Further, in describing representative embodiments, the specification may have presented methods and/or processes as a particular sequence of steps. However, to the extent that the methods or processes do not rely on the particular order of steps set forth herein, the methods or processes should not be limited to the particular sequence of steps described. As one of ordinary skill in the art would appreciate, other sequences of steps may be possible. Therefore, the particular order of the steps set forth in the specification should not be construed as limitations on the claims.

While the invention is susceptible to various modifications, and alternative forms, specific examples thereof have been shown in the drawings and are herein described in detail. It should be understood, however, that the invention is not to be limited to the particular forms or methods disclosed, but to the contrary, the invention is to cover all modifications, equivalents and alternatives falling within the scope of the appended claims.

That which is claimed:

1. A method of preparing an egg substitute composition, comprising:
a. Preparing an oil in water emulsion mix;
b. Homogenizing the emulsion mix;
c. Preparing a mixture of ortho salts;
d. Preparing a blending complex comprising a macro complex including proteins, carbohydrates, and insoluble fibers; and a micro complex including the ortho salts;
e. Extruding a mixture comprising the homogenized emulsion mixture and the blending complex yielding a hydrated egg replacement composition.

2. The method of claim 1, wherein the emulsion mix comprises an oil phase including emulsifiers and stabilizers and the aqueous phase includes lubricants and buffer salts.

3. The method of claim 1, wherein the homogenizing step reduces size of fat globules in the emulsion mix.

4. The method of claim 1, wherein the ortho salts are formed at least in part by hydration of anhydrous salts.

5. The method of claim 1, wherein the extrusion step results in the coating of solid particles by a thin uniform and temperature resistant film formed by the homogenized emulsion.

6. The method of claim 3, wherein the reduction in size of fat globules creates a composition having physiochemical characteristics similar to those of fresh eggs.

7. The method of claim 4, wherein the ortho salts result in a food composition with enhanced hydration characteristics.

8. The method of claim 1, further comprising:
a. drying the egg replacement composition; and
b. homogenizing the dry egg replacement composition.

9. The method of claim 8, wherein the egg replacement composition has a hydration ratio from about 1:4 (egg replacement composition:water) to about 1:6 (egg replacement composition:water).

10. The method of claim 1, wherein the preparation of the oil in water emulsion mix forms a uniform thin film for coating the protein particles of the macro complex.

11. The method of claim 10, wherein the thin film aids in retention of moisture by the protein particles and expansion thereof.

12. The method of claim 4, wherein the hydration of the salts aids in moisture retention and water activity control of the composition.

13. The method of claim 4, wherein the salts minimizes the coagulation during the hydrolysis of the proteins.

14. An egg substitute composition, comprising: proteins, fats, binding agents, emulsifiers, enzymes, thickening agents, and mineral salts; the composition having a hydration ratio from about 1:4 (egg replacement composition:water) to about 1:6 (egg replacement composition:water).

15. The composition of claim 14, wherein the composition has a shelf life up to about 12 months.

16. The composition of claim 14, wherein the composition does not require any refrigeration.

17. The composition of claim 11, wherein the composition comprises from about 1 to about 30% by weight protein, from about 0 to about 30% by weight fats, from about 1 to about 45% by weight binding agents, from about 0 to about 25% by weight emulsifiers, from about 0.01 to about 0.08% by weight enzymes, from about 0 to about 20% by weight thickening agents, and from about 0.02 to about 2.50% by weight mineral salts.

18. The composition of claim 14, wherein the composition is an aqueous composition ready for use to prepare a final food product.

19. A method of preparing an egg substitute composition, comprising:
a. Preparing an oil in water emulsion mix;
b. Homogenizing the emulsion mix to activate the emulsifying agents in the emulsion mix;
c. Preparing a mixture of ortho salts;
d. Preparing a macro complex including proteins, carbohydrates, and insoluble fibers;
e. Hydrating the macro complex by mixing the macro complex with a micro complex including the ortho salts; and
f. Extruding a mixture comprising the homogenized emulsion mixture and the hydrated complex yielding a hydrated egg replacement composition.
